(19) United States
(12) Patent Application Publication
(10) Pub. No.: US 2012/0295544 A1
(43) Pub. Date: Nov. 22, 2012

(54) EXCLUSIVE-LOCK CONTROL METHOD FOR RADIO COMMUNICATION DEVICE

(75) Inventors: Osamu OIKAWA, Sapporo (JP); Nana UENO, Sapporo (JP); Kenji WATANABE, Sapporo (JP); Katsuaki AKAMA, Yokohama (JP)

(73) Assignee: FUJITSU LIMITED, Kawasaki-shi (JP)

(21) Appl. No.: 13/473,188

(22) Filed: May 16, 2012

(30) Foreign Application Priority Data
May 20, 2011 (JP) 2011-113671

(51) Int. Cl. H04B 7/24

(52) U.S. Cl. 455/41.2

(57) ABSTRACT

A radio communication device includes, a radio communication device includes, a plurality of IC chips that conducts radio communicate with a reader/writer, a first setting unit that sets one IC chip selected from the plurality of IC chips to an exclusive-lock release state that allows radio communication to be conducted with the reader/writer, a determination unit that determines whether the radio communication is being conducted normally when radio communication between the one IC chip set to the exclusive-lock release state and the reader/writer is conducted, and a second setting unit that sets the one IC chip set to the exclusive-lock release state to a exclusive-locked state that does not allow radio communication with the reader/writer when the radio communication is determined as not being conducted normally, and sets another IC chip that is different from the one IC chip set to the exclusive-locked state to the exclusive-lock release state.

### CROSS-REFERENCE TO RELATED APPLICATION(S)

This application is based upon and claims the benefit of priority of the prior Japanese Patent Application No. 2011-113671, filed on May 20, 2011, the entire contents of which are incorporated herein by reference.

### FIELD

The embodiment discussed herein is related to an exclusive-lock control method for a radio communication device.

### BACKGROUND

Radio frequency identification (RFID) technology that conducts the transfer of identification (ID) information between a radio communication device and a reader/writer (R/W) using radio communication across a short distance is conventionally known in the art. The reader/writer (R/W) include reader and writer functions. Recently, an RFID integrated circuit (IC) chip is loaded into a radio communication device such as a mobile telephone so that radio communication can be conducted between the radio communication device and reader/writers or other opposing devices placed outside the radio communication device to conduct settlements such as monetary payments and the like. Such radio communication is not limited to communication with reader/writers and radio communication is also frequently conducted with other radio communication devices loaded with RFID IC chips.

International Organization for Standardization (ISO) 14443 is widely known around the world as a short distance radio communication protocol used in such RFID technology. Independent standards such as FeliCa™ are used in Japan.

Meanwhile, due to the expansion of the smartphone market, smartphones are recently equipped with near field communication (NFC) chip-based functions (for example, MIFARE™ card communication) complying with ISO 14443.

Under these conditions, it is known in the art that the FeliCa™ Application Program Interface has been added to NFC chips to allow for Japan domestic FeliCa™ communication with internationally oriented NFC chips.

Moreover, it is known that a plurality of electronic money applications are incorporated into an IC chip mounted in a mobile phone such that a reader/writer conducts settlement processing according to a priority ranking among the plurality of electronic money applications (see, for example, Japanese Patent Laid-open No. 2005-252613 and Japanese Patent Laid-open No. 2009-176065).

However, the technology disclosed in the above reference documents does not take into account the occurrence of communication problems in the radio communication devices having a plurality of IC chips for short distance radio communication.

Specifically, a FeliCa™ chip is installed in a radio communication device such as a smartphone used in Japan, and settlement processing is conducted using radio communication through the FeliCa™ chip. However more recently, there is demand for a radio communication device that can conduct settlement processing with a short distance radio communication protocol that can be used worldwide instead of only in Japan.

Accordingly, by incorporating, for example, an NFC chip into a radio communication device with a FeliCa™ chip, it is possible that settlement processing using short distance radio communication can be conducted both in Japan and in other countries. However when a plurality of IC chips for short distance radio communication are installed in a radio communication device, there is a fear that communication radio waves may be disturbed causing communication problems due to the plurality of IC chips communicating at the same time in the same way as if, for example, a plurality of card-type IC cards for short distance radio communication were stacked one on top of another and used.

The term “short distance radio communication” indicates a radio communication technique such as infrared radiation, Bluetooth™, FeliCa™ and the like, and may also be called a non-contact radio communication technique. The “short distance” of short distance radio communication refers to, for example, a distance of several centimeters to several meters for communication depending on a frequency band.

### SUMMARY

According to an aspect of the invention, a radio communication device includes, a plurality of IC chips that conducts radio communicate with a reader/writer, a first setting unit that sets one IC chip selected from the plurality of IC chips to an exclusive-lock release state that allows radio communication to be conducted with the reader/writer, a determination unit that determines whether the radio communication is being conducted normally when radio communication between the one IC chip set to the exclusive-lock release state and the reader/writer is conducted, and a second setting unit that sets the one IC chip set to the exclusive-lock release state to a exclusive-locked state that does not allow radio communication with the reader/writer when the radio communication is determined as not being conducted normally, and sets another IC chip that is different from the one IC chip set to the exclusive-locked state to the exclusive-lock release state.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an overview of an exclusive-locked state of a mobile telephone.

FIG. 2 is a block diagram of a hardware configuration of a mobile telephone.

FIG. 3 illustrates an example of information stored in a memory inside an IC card chip.

FIG. 4 is a functional block diagram of a mobile telephone.

FIG. 5 is a flow chart of mobile telephone procedures.

FIG. 6 is a flow chart of mobile telephone procedures.

FIG. 7 is a flow chart of mobile telephone procedures.

FIG. 8 is a block diagram of a hardware configuration of a mobile telephone.

### DESCRIPTION OF EMBODIMENT

The following will describe in detail an embodiment of a radio communication device and a communication control program disclosed herein with reference to the drawings. The embodiment is not limited to the features disclosed herein. For example, although the following embodiment describes a mobile telephone as an example of a radio communication device, the embodiment is not limited as such and may refer to a radio communication device equipped with a plurality of IC card chips that conduct radio communication with a reader/writer. A mobile terminal device includes, for example, a mobile telephone, a personal digital assistant (PDA), a portable personal computer (PC), and the like.

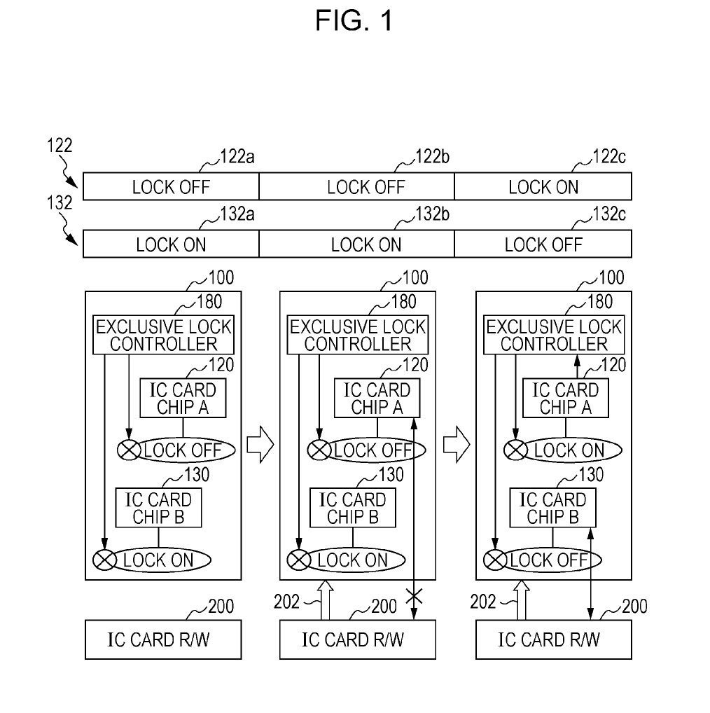

FIG. 1 illustrates an overview of an exclusive-locked state of a mobile telephone. FIG. 1 chronologically illustrates from the left side to the right side of the drawing how radio communication between a mobile telephone 100 and an IC card R/W 200 is conducted. The mobile telephone 100 includes an IC card chip A 120 and an IC card chip B 130. The IC card chip A 120 is for example a FeliCa™ chip, and the IC card chip B 130 is for example an NFC chip. In the example in FIG. 1, the IC card R/W 200 is an R/W that can conduct radio communication with the IC card chip B 130, but does not conduct radio communication with the IC card chip A 120. The example in FIG. 1 only illustrates the IC card chip A 120, the IC card chip B 130, and an exclusive-lock controller 180 in the mobile telephone 100 configuration to allow for the simplification of the description. Details of the mobile telephone 100 will be explained hereinbelow.

A exclusive-lock state map 122 in FIG. 1 represents the exclusive-lock states of the IC card chip A 120. A exclusive-lock state map 132 represents the exclusive-lock states of the IC card chip B 130. As illustrated by the exclusive-lock state maps 122 and 132, the mobile telephone 100 uses the exclusive exclusive-lock controller 180 to first set the IC card chip A 120 to a exclusive-lock release state 122a (exclusive-lock off) that allows for radio communication to be conducted with the IC card R/W 200 as an initial state. The mobile telephone 100 also uses the exclusive-lock controller 180 to set the IC card chip B 130 to a exclusive-locked state 132a (exclusive-lock on) that does not allow for radio communication to be conducted with the IC card R/W 200 as an initial state.

Under these states, the mobile telephone 100 receives carrier waves 202 sent from the IC card R/W 200. At this time, the IC card chip B 130 is in a exclusive-locked state 132b and the IC card chip A 120 is in a exclusive-lock release state 122b such that radio communication is conducted between the IC card chip A 120 and the IC card R/W 200. However, since the IC card R/W 200 is an R/W for conducting radio communication with the IC card chip B 130, the IC card R/W 200 does not conduct radio communication normally with the IC card chip A 120.

Thus the mobile telephone 100 uses the exclusive-lock controller 180 to set the IC card chip A 120 to a exclusive-locked state 122c and to set the IC card chip B 130 to a exclusive-lock release state 132c. Specifically, the exclusive-locked states of the IC card chip A 120 and the IC card chip B 130 are switched. Thus, the IC card chip B 130 enters the exclusive-lock release state allowing for radio communication between the IC card chip B 130 and the IC card R/W 200. Since the IC card R/W 200 is an R/W for conducting radio communication with the IC card chip B 130, the IC card R/W 200 can conduct radio communication normally with the IC card chip B 130.

According to the mobile telephone 100 of the present embodiment, concurrent radio communication with the IC card R/W 200 conducted by the IC card chip A 120 and the IC card chip B 130 is not performed. Therefore, the occurrence of communication problems due to confusion (disturbance) of the radio waves caused by a plurality of IC card chips concurrently conducting radio communication can be suppressed by the mobile telephone 100 of the present embodiment. The following is a detailed description of the mobile telephone 100.

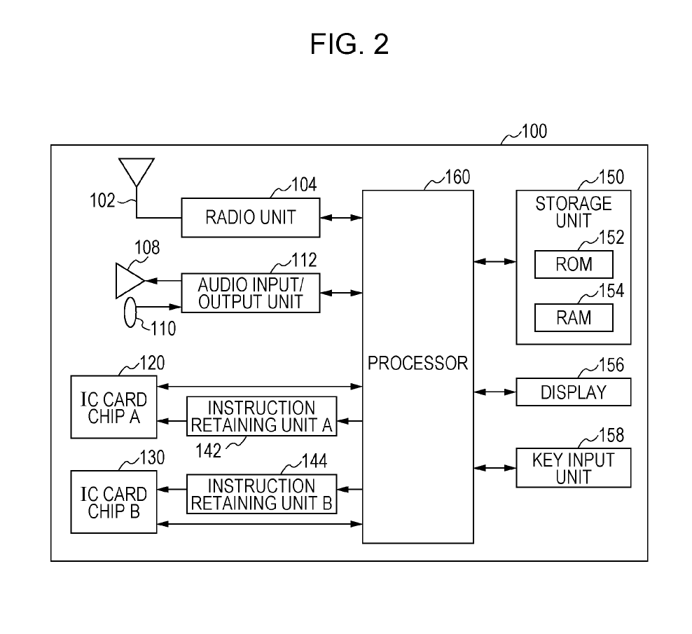

FIG. 2 is a block diagram of a hardware configuration of a mobile telephone. As illustrated in FIG. 2, the mobile telephone 100 according to the present embodiment includes an antenna 102, a radio unit 104, a speaker 108, a microphone 110, and an audio input/output unit 112. The mobile telephone 100 also includes the IC card chip A 120, the IC card chip B 130, an instruction retaining unit A 142, an instruction retaining unit B 144, a storage unit 150, a display 156, a key input unit 158, and a processor 160.

The radio unit 104 conducts radio communication of data such as voice and text through the antenna 102. The audio input/output unit 112 is an input/output interface that inputs sound through a microphone 110, and outputs sound through a speaker 108.

The IC card chip A 120 is, for example, a FeliCa™ chip, and conducts radio communication with an R/W located outside of the mobile telephone 100, and conducts radio communication with another radio communication device equipped with a FeliCa™ chip and the like. The IC card chip B 130 is, for example, an NFC chip, and conducts radio communication with an R/W located outside of the mobile telephone 100, and conducts radio communication with another radio communication device equipped with an NFC chip and the like. The IC card chip A 120 and the IC card chip B 130 are connected to, for example, a Universal Asynchronous Receiver Transmitter (UART) port of the processor 160 to allow for sending and receiving various types of data to and from the processor 160 through the UART port. In the following explanation, the R/W located outside the mobile telephone 100 and the other radio communication device equipped with an IC card chip such as the FeliCa™ chip or the NFC chip are both referred to as an IC card R/W 200. Moreover, both the IC card chip A 120 and the IC card chip B 130 have an enable/disable pin such that when input signals inputted to the pin are high, the IC card chips enter into a state in which radio communication is possible, and when input signals inputted to the pins are low, the IC card chips enter into a state in which radio communication is not possible.

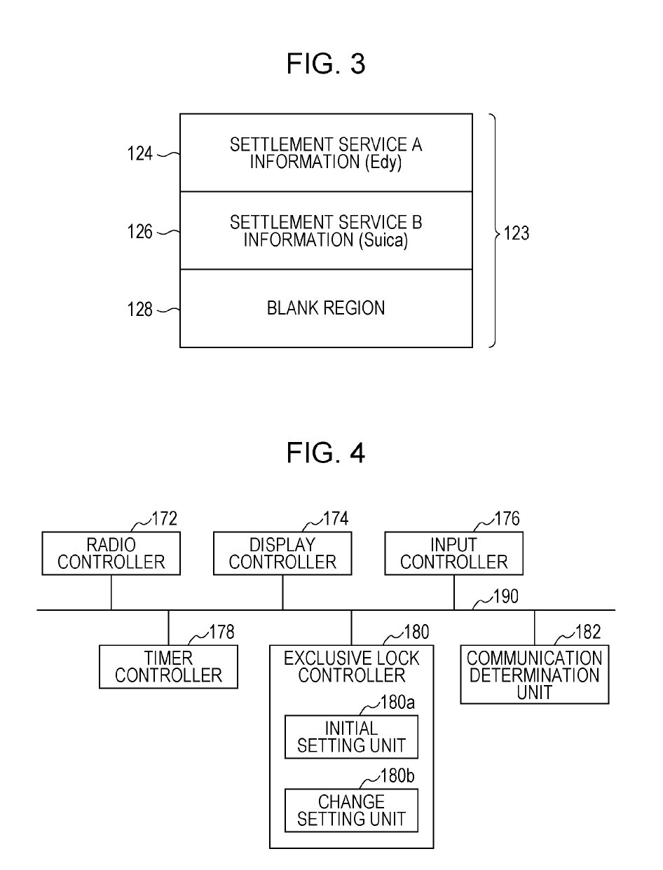

The following describes an example of information stored in a memory inside the IC card chip A 120. FIG. 3 illustrates an example of information stored in a memory inside an IC card chip. FIG. 3 illustrates an example of information stored inside the memory of the IC card chip A 120 when the IC card chip A 120 is a FeliCa™ chip. As illustrated in FIG. 3, a storage area 123 of the IC card chip A 120 includes information 124 that relates to a settlement service A (for example, Edy™), information 126 that relates to a settlement service B (for example, Suica™), and a blank area 128. For example, when the settlement service A is settled by the mobile telephone 100 conducting radio communication with the IC card R/W 200, the information 124 is overwritten, and when the settlement service B is settled, the information 126 is overwritten. In this way, information related to a plurality of settlement services can be stored in the storage area 123 of the IC card chip A 120 instead of only information relating to one settlement service, and thus the IC card chip A 120 can accommodate the plurality of settlement services.

Referring back to FIG. 2, the instruction retaining unit A 142 and the instruction retaining unit B 144 are, for example, flip-flop circuits that instruct the enablement or disablement of the radio communication of the IC card chips A 120 and B 130 by making signals sent to the enable/disable pin of the IC card chip A 120 or the IC card chip B 130 high or low according to an input from the processor 160. The instruction retaining unit A 142 instructs the enablement or disablement for the IC card chip A 120 and the instruction retaining unit B 144 instructs the enablement or disablement for the IC card chip B 130.

The storage unit 150 includes a read only memory (ROM) 152 that stores data for conducting various functions of the mobile telephone 100, and a random access memory (RAM) 154 that stores various programs for conducting the various functions. Information inside the IC chips about the radio communication previously conducted by one of the IC chips with, for example, the IC card R/W 200 is stored in the storage unit 150. The display 156 is an input/output interface such as a liquid crystal panel and the like that displays information such as text and images. The key input unit 158 includes various types of operating keys provided on the mobile telephone 100, and is an input interface that receives operations inputted by a user.

The processor 160 is an arithmetic processing unit such as a central processing unit (CPU) and the like that implements various types of programs stored in the ROM 152 or the RAM 154. The processor 160 controls the abovementioned radio unit 104, the audio input/output unit 112, the IC card chip A 120, the IC card chip B 130, the instruction retaining unit A 142, the instruction retaining unit B 144, the display 156, and the key input unit 158 by implementing the various types of programs stored in the ROM 152 or the RAM 154. The programs implemented by the processor 160 are not only stored in the ROM 152 or the RAM 154, but may also be recorded in a distributable recording medium such as a compact disc-read only memory (CD-ROM) or a memory medium and the like thus allowing the programs to be read out from the memory medium and implemented. Moreover, the programs may be stored on a server connected via a network to allow the programs to be operated on the server, thus allowing services to be provided on the mobile telephone 100 requesting such services according to the request from the mobile telephone 100 connected via the network.

The following describes functional blocks of the mobile telephone 100. FIG. 4 is a functional block diagram of the mobile telephone. As illustrated in FIG. 4, the mobile telephone 100 includes as functional blocks a radio controller 172, a display controller 174, an input controller 176, a timer controller 178, the exclusive-lock controller 180, and a communication determination unit 182. The radio controller 172, the display controller 174, the input controller 176, the timer controller 178, the exclusive-lock controller 180, and the communication determination unit 182 are achieved by the processor 160 reading out and implementing the various programs from the ROM 152 or the RAM 154. The radio controller 172, the display controller 174, the input controller 176, the timer controller 178, the exclusive-lock controller 180, and the communication determination unit 182 are all interconnected through a data bus 190.

The radio controller 172 controls the radio communication of various types of data such as sound and text and the like with a communication partner such as a mobile telephone and the like through a base station, by controlling the radio unit 104. The display controller 174 conducts controls to allow the display 156 to display various types of information such as text and images and the like stored in the storage unit 150. The input controller 176 controls the reception of input operations inputted by a user through the key input unit 158.

The timer controller 178 determines whether or not a previously set time has elapsed after the IC card chip set to the exclusive-lock release state by the exclusive-lock controller 180 has received radio signals sent from the IC card R/W 200.

The exclusive-lock controller 180 includes an initial setting unit 180a and a change setting unit 180b. The initial setting unit 180a sets one of the IC card chips among the IC card chip A 120 and the IC card chip B 130, to the exclusive-lock release state. For example, the initial setting unit 180a sets the IC card chip A 120 to the exclusive-lock release state as an initial state of the mobile telephone 100. The exclusive-lock controller 180 sets the IC card chip B 130 to a exclusive-locked state that does not allow for radio communication to be conducted with the IC card R/W 200 as an initial state of the mobile telephone 100. For example, the initial setting unit 180a sets the IC card chip A 120 to the exclusive-lock release state during initialization processing when the power of the mobile telephone 100 is turned on to activate the mobile telephone 100.

The change setting unit 180b sets the IC card chip set to the exclusive-lock release state to the exclusive-locked state when the communication determination unit 182 determines that radio communication between the IC card chip set to the exclusive-lock release state and the IC card R/W 200 is not being conducted normally. Additionally, the change setting unit 180b sets another IC card chip that is different from the IC card chip set to the exclusive-locked state by the change setting unit 180b, to the exclusive-lock release state. For example, the change setting unit 180b sets the IC card chip A 120 to the exclusive-locked state when it is determined that radio communication between the IC card chip A 120 set to the exclusive-lock release state and the IC card R/W 200 is not being conducted normally. The change setting unit 180b also sets the IC card chip B 130 to the exclusive-lock release state.

The change setting unit 180b sets the IC card chip A 120 to the exclusive-locked state and sets the IC card chip B 130 to the exclusive-lock release state upon completion of the reading out and saving of the information inside the IC card chip A 120 in the initialization processing.

The initial setting unit 180a and the change setting unit 180b instruct the instruction retaining unit corresponding to the IC card chip set to the exclusive-lock release state among the IC card chip A 120 and the IC card chip B 130, to enable radio communication. If the instruction retaining unit is a flip-flop circuit, the instruction retaining unit conducts a single CLK input and inputs a high signal to a D input. As a result, the particular instruction retaining unit inputs and saves the high signal to the enable/disable pin of the corresponding IC card chip such that the IC card chip enters the state of being able to conduct radio communication. In this way, the initial setting unit 180a and the change setting unit 180b control the exclusive-locked states and/or exclusive-lock release states of the IC card chip A 120 and the IC card chip B 130.

The communication determination unit 182 determines whether or not radio communication is being conducted normally while the radio communication is being conducted between the IC card R/W 200 and the IC card chip set to the exclusive-lock release state by the initial setting unit 180a or the change setting unit 180b. For example, the communication determination unit 182 determines whether or not radio communication is being conducted normally with the IC card R/W 200 according to whether or not the information stored inside the IC card chip set to the exclusive-lock release state has changed after conducting the radio communication. Specifically, the determining uses the characteristic that, for example, the information written in the IC card chip changes if the settlement processing is conducted normally due to the radio communication with the IC card R/W 200, and does not change if the settlement processing is not conducted normally.

For example, the communication determination unit 182 stores ahead of time the information inside the IC card chip before the IC card chip set to the exclusive-lock release state conducts radio communication, in the storage unit 150. The communication determination unit 182 then reads out the information corresponding to the IC card chip set to the exclusive-lock release state from the storage unit 150 if radio communication is conducted between the IC card chip set to the exclusive-lock release state and the IC card R/W 200. The communication determination unit 182 then determines whether or not there are any changes in the information after conducting the radio communication by comparing the information read out from the storage unit 150 and the information stored inside the IC card chip set to the exclusive-lock release state. The communication determination unit 182 stores in the storage unit 50 the information stored inside the IC card chip set to the exclusive-lock release state after determining that there is a change in the information inside the IC chip after the IC card chip set to the exclusive-lock release state conducts the radio communication. In this way, the communication determination unit 182 stores ahead of time card information of a plurality of IC card chips in the storage unit 150 as criteria to decide the valid IC card chip that can conduct radio communication normally with the IC card R/W 200 among the plurality of IC card chips.

For example, the communication determination unit 182 determines whether or not radio communication is being conducted normally between the IC card R/W 200 and the IC card chip set to the exclusive-lock release state if the timer controller 178 determines that a previously set time has elapsed. The determining is conducted using the timer controller 178 after a timeout since the settlement processing is not completed by the IC card chip when, for example, settlement processing is being conducted by radio communication between the IC card chip and the IC card R/W 200.

When the power of the mobile telephone 100 is turned on to activate the mobile telephone 100 in the initialization processing, the communication determination unit 182 reads out the information stored inside the IC card chip set to the exclusive-lock release state and stores the information in the storage unit 150.

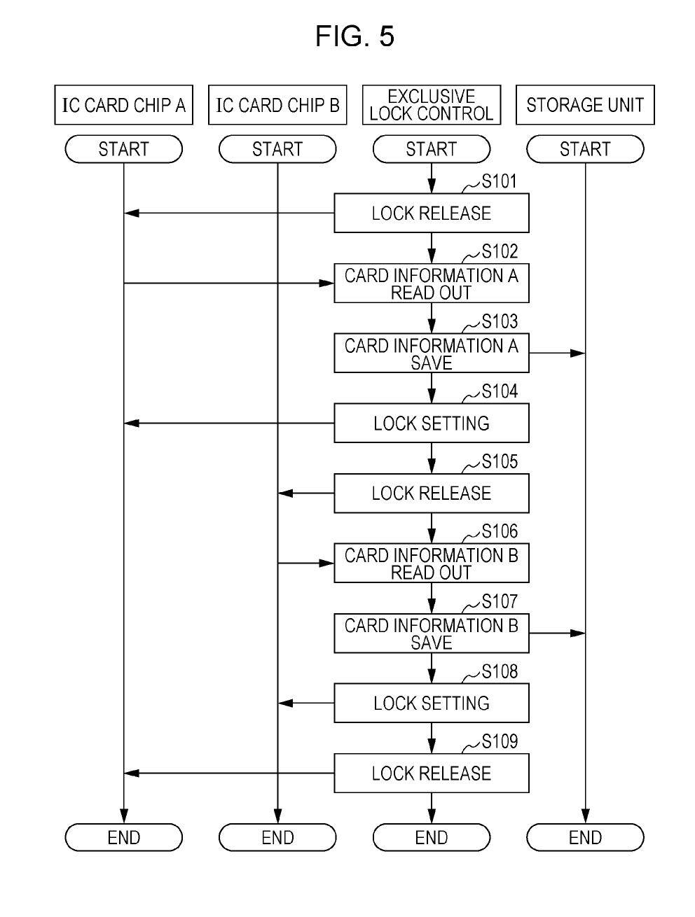

The following describes processing of the mobile telephone 100. FIG. 5 is a flow chart of mobile telephone procedures. The flow chart in FIG. 5 is a flow chart of initial processing conducted when, for example, the power of the mobile telephone 100 is turned on to activate the mobile telephone 100. For convenience, processing conducted by the exclusive-lock controller 180 and the communication determination unit 182 is described as “exclusive-lock control.” It is assumed in the mobile telephone 100 that the IC card chip A 120 is set as the IC card chip for preferentially conducting radio communication with the IC card R/W 200 among the IC card chip A 120 and the IC card chip B 130.

The initial setting unit 180a first sets the IC card chip A 120 to the exclusive-lock release state (step S101). The communication determination unit 182 then reads out card information A stored in the IC card chip A 120 (step S102) and then saves the read out card information A in the storage unit 150 (step S103). As a result, the card information A before the IC card chip A 120 conducts radio communication with the IC card R/W 200 is stored in the storage unit 150.

The change setting unit 180b sets the IC card chip A 120 to the exclusive-locked state (step S104), and sets the IC card chip B 130 to the exclusive-lock release state (step S105). The communication determination unit 182 then reads out card information B stored in the IC card chip B 130 (step S106), and saves the read out card information B in the storage unit 150 (step S107). As a result, the card information B before the IC card chip B 130 conducts radio communication with the IC card R/W 200 is stored in the storage unit 150.

The initial setting unit 180a sets the IC card chip B 130 to the exclusive-locked state (step S108), and sets the IC card chip A 120 to the exclusive-lock release state (step S109). That is, the initial setting unit 180a sets the IC card chip A 120 to the exclusive-lock release state ahead of time since the IC card chip A 120 is set to preferentially conduct radio communication with the IC card R/W 200.

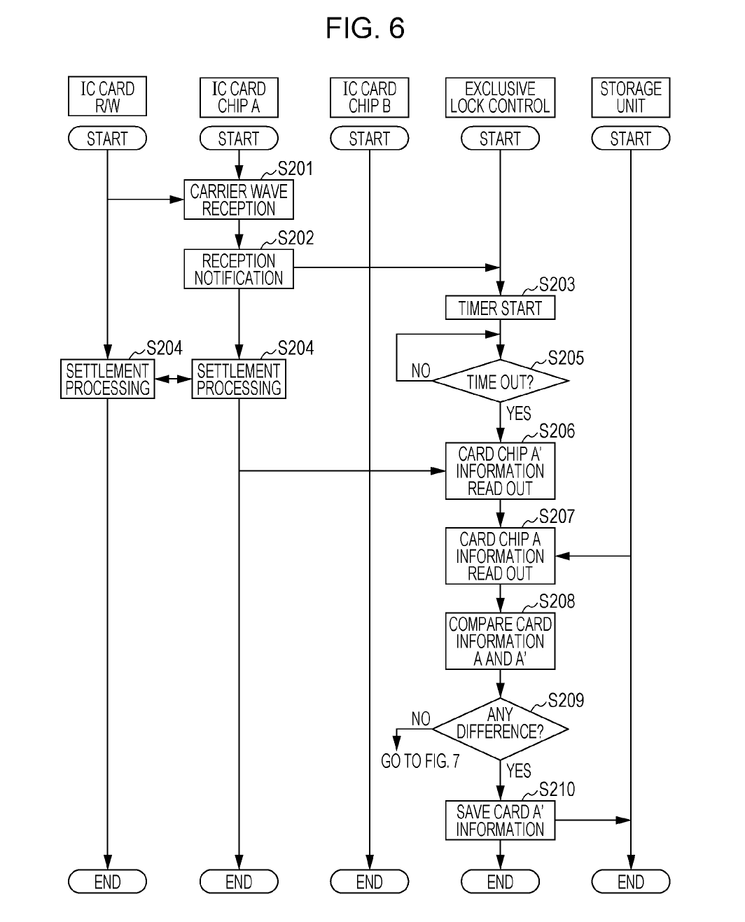

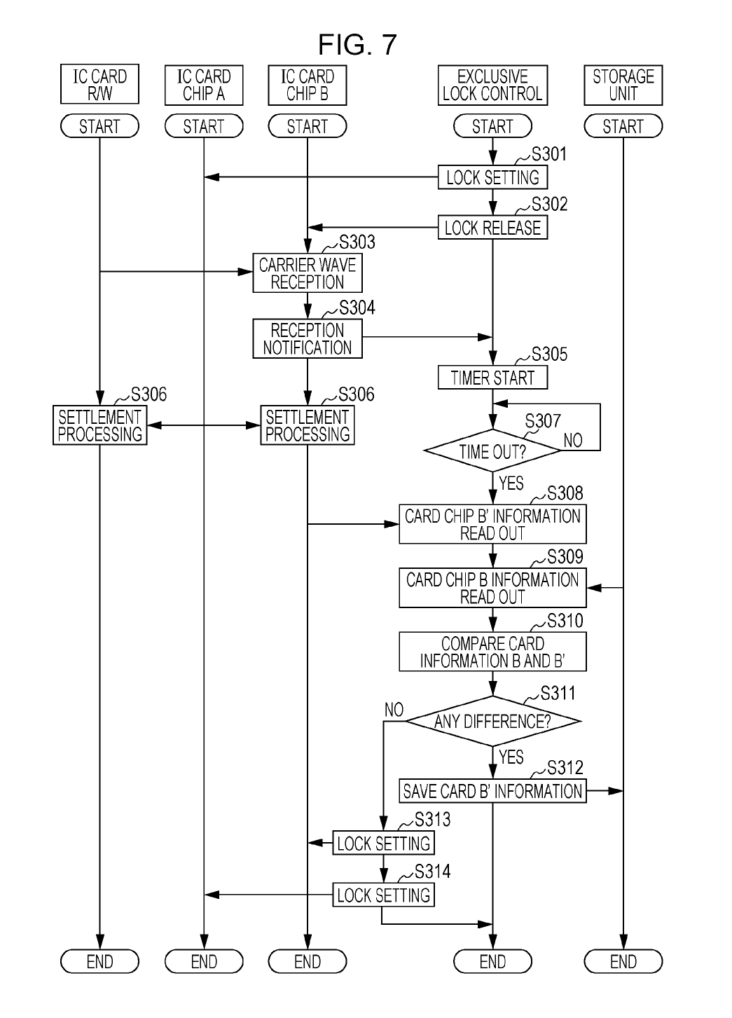

Next, processing of the mobile telephone 100 for conducting radio communication with the IC card R/W 200 will be described. FIGS. 6 and 7 are flow charts of mobile telephone procedures. For convenience, processing conducted by the timer controller 178, the exclusive-lock controller 180, and the communication determination unit 182 is described as “exclusive-lock control.”

For example, when a user holds the mobile telephone 100 toward the IC card R/W 200, the IC card chip A 120 receives carrier waves sent by the IC card R/W 200 since only the IC card chip A 120 is set to the exclusive-lock release state (step S201). The IC card chip A 120 notifies the timer controller 178 that the carrier waves were received from the IC card R/W 200 (step S202).

The timer controller 178 starts a timer (step S203) upon receiving the notification from the IC card chip A 120 that the carrier waves sent by the IC card R/W 200 were received. Meanwhile, the settlement processing enabled by the radio communication being conducted between the IC card chip A 120 and the IC card R/W 200 is conducted (step S204). The timer controller 178 determines whether or not a previously set time (for example, 2 seconds) after the activation of the timer has elapsed and timed out while the settlement processing between the IC card chip A 120 and the IC card R/W 200 is being conducted (step S205). The previously set time may be appropriately set as a time indicating when the settlement based on the radio communication between the IC card chip and the IC card R/W 200 may likely be finished. The timer controller 178 returns to step S205 if the previously set time after starting the timer has not elapsed (step S205: No).

Meanwhile, when it is determined that the previously set time after starting the timer has elapsed (step S205: Yes), the communication determination unit 182 reads out card information A′ stored in the IC card chip A 120 (step S206). The communication determination unit 182 also reads out the card information A stored in the storage unit 150 (step S207).

The communication determination unit 182 compares the read out card information A and the card information A′ (step S208), and determines whether or not there is any difference between the card information A and the card information A′ (step S209). If the communication determination unit 182 determines that there is a difference between the card information A and the card information A′ (step S209: Yes), the communication determination unit 182 stores the card information A′ in the storage unit 150 (step S210), and the processing is finished. Specifically, the fact that there is a difference between the card information A and the card information A′ indicates that the radio communication between the IC card chip A 120 and the IC card R/W 200 was conducted normally, and that the IC card chip A 120 is the valid IC card chip. The communication determination unit 182 then stores the updated card information A′ of the IC card chip A 120 in the storage unit 150 to be used for the next determination.

If the change setting unit 180b determines that there is no difference between card information A and card information A′ (step S209: No), the processing moves to the flow chart illustrated in FIG. 7. The change setting unit 180b sets the IC card chip A 120 to the exclusive-locked state (step S301), and sets the IC card chip B 130 to the exclusive-lock release state (step S302) as illustrated in FIG. 7. Specifically, the fact that there is no difference between the card information A and the card information A′ indicates that the radio communication between the IC card chip A 120 and the IC card R/W 200 was not conducted normally, and that the IC card chip A 120 is an invalid IC card chip. The change setting unit 180b sets the IC card chip A 120 to the exclusive-locked state and sets the IC card chip B 130 that is different from the IC card chip A 120 to the exclusive-lock release state. As a result, the communication target with the IC card R/W 200 is automatically switched to the IC card chip B 130.

The IC card chip B 130 receives carrier waves sent by the IC card R/W 200 since only the IC card chip B 130 is set to the exclusive-lock release state (step S303). The IC card chip B 130 notifies the timer controller 178 that the carrier waves were received from the IC card R/W 200 (step S304).

The timer controller 178 starts the timer (step S305) upon receiving the notification from the IC card chip B 130 that the carrier waves sent by the IC card R/W 200 were received. Meanwhile, the settlement processing enabled by the radio communication being conducted between the IC card chip B 130 and the IC card R/W 200 is conducted (step S306). The timer controller 178 determines whether or not a previously set time (for example, 2 seconds) after the activation of the timer has elapsed and timed out while the settlement processing between the IC card chip B 130 and the IC card R/W 200 is being conducted (step S307). The timer controller 178 returns to step S307 if the previously set time after starting the timer has not elapsed (step S307: No).

Meanwhile, when it is determined that the previously set time after starting the timer has elapsed (step S307: Yes), the communication determination unit 182 reads out card information B′ stored in the IC card chip B 130 (step S308). The communication determination unit 182 also reads out the card information B stored in the storage unit 150 (step S309).

The communication determination unit 182 compares the read out card information B and the card information B′ (step S310) to determine whether or not there is a difference between the card information B and the card information B′ (step S311). If the communication determination unit 182 determines that there is a difference between the card information B and the card information B′ (step S311: Yes), the communication determination unit 182 saves the card information B′ in the storage unit 150 (step S312) and the processing is finished. Specifically, the fact that there is a difference between the card information B and the card information B′ indicates that radio communication was conducted normally between the IC card chip B 130 and the IC card R/W 200, and thus the updated card information B′ is saved in the storage unit 150 to be used for the next evaluation. Since the IC card chip B 130 is evaluated as a valid IC card chip B 130 in this case, the IC card chip B 130 is kept in the exclusive-lock release state and the IC card chip A 120 is kept in the exclusive-locked state.

If, on the other hand, the initial setting unit 180a determines that there is no difference between the card information B and the card information B′ (step S311: No), the initial setting unit 180a sets the IC card chip B 130 to the exclusive-locked state (step S313). The initial setting unit 180a then sets the IC card chip A 120 to the exclusive-lock release state (step S314) and the processing is finished. Specifically, the fact that there is no difference between the card information B and the card information B′ indicates that the radio communication between either the IC card chip A 120 or the IC card chip B 130 and the IC card R/W 200 was not conducted normally. The initial setting unit 180a sets the IC card chip B 130 to the exclusive-locked state and sets the IC card chip A 120 to the exclusive-lock release state to return to the initial state.

As described above, the occurrence of communication problems in a radio communication device having a plurality of IC card chips for conducting short distance radio communication can be suppressed by the mobile telephone 100 of the present embodiment. Specifically, the mobile telephone 100 exclusively switches the exclusive-locked states of the IC card chip A 120 and the IC card chip B 130 to “exclusive-locked state, exclusive-locked state,” “exclusive-locked state, exclusive-lock release state,” and “exclusive-lock release state, exclusive-locked state.” The mobile telephone 100 also determines whether or not there is a valid IC card chip that can conduct radio communication normally with the IC card R/W 200 by checking for the presence of changes in the information in the IC card chips, and then changes the exclusive-locked state. Thus, the valid IC card chip can be automatically selected by the mobile telephone 100. Moreover, the occurrence of communication problems due to confusion (disturbance) of the radio waves caused by a plurality of IC card chips concurrently conducting radio communication can be suppressed by the mobile telephone 100.

The present embodiment describes an example in which two IC card chips, the IC card chip A 120 and the IC card chip B 130, are mounted in the mobile telephone 100. However, the present embodiment is not limited as such and a mobile telephone having, for example, three or more IC card chips is also applicable to the present embodiment in a similar way. For example, the initial setting unit 180a sets one of the IC card chips among the plurality of IC card chips to the exclusive-lock release state even if the mobile telephone includes three or more IC card chips. The communication determination unit 182 determines whether or not radio communication is being conducted normally while the radio communication is being conducted between the IC card R/W 200 and the IC card chip set to the exclusive-lock release state. The change setting unit 180b then sets the IC card chip set to the exclusive-lock release state to the exclusive-locked state when the communication determination unit 182 determines that radio communication is not being conducted normally. Additionally, the change setting unit 180b sets another IC card chip that is different from the IC card chip set to the exclusive-locked state, to the exclusive-lock release state. As a result, the occurrence of communication problems caused by concurrent communication of a plurality of IC card chips can be suppressed as described in the above embodiment even with a mobile telephone 100 including, for example, three or more IC card chips.

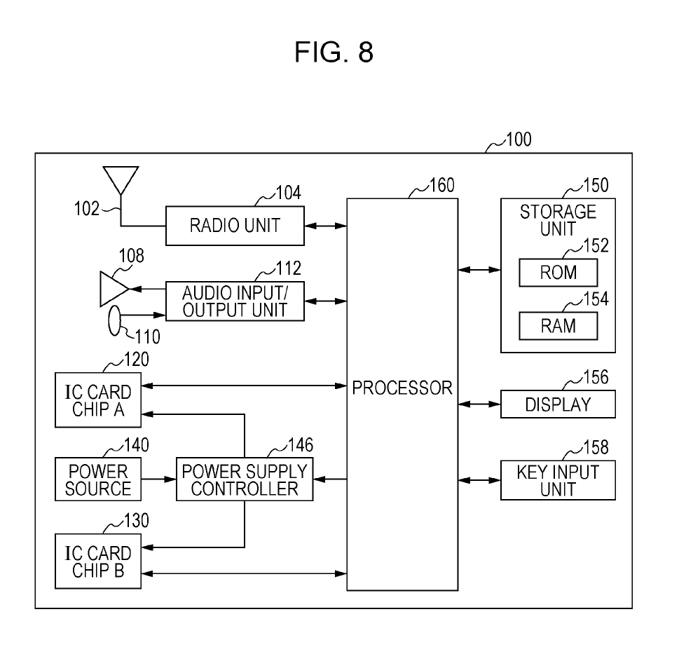

Although an example in which the IC card chip has an enable/disable pin and the enablement or disablement of radio communication is controlled by signals inputted into the enable/disable pin in the above embodiment, the embodiment is not limited to this control method. For example, enablement or disablement of radio communication of the IC card chip may be controlled by supplying or not supplying power to the IC card chip. The IC card chip may be a type that operates not only by the supply of power from carrier waves from a reader/writer, but may be a type that is supplied power from a battery or the like of the mobile telephone 100 to allow for the operation of the IC card chip. FIG. 8 is a bexclusive-lock diagram of another example of a hardware configuration of a mobile telephone. As illustrated in FIG. 8, if a type of IC card chip is used that is caused to operate initially based on a supply of power from a power source 140 of the mobile telephone 100, a power supply controller 146 is provided that controls the supply of power according to an instruction from the processor 160 such that the supply of power to the IC card chip A 120 or to the IC card chip B 130 is controlled by using the power supply controller 146.

The present embodiment is not limited to the above description focusing mainly on a mobile telephone. Additionally, the above-mentioned present embodiment may achieve similar functions by implementing a previously prepared communication control program with a computer. Specifically, the communication control program is caused to set one IC chip among the plurality of IC chips to a exclusive-lock release state that allows radio communication to be conducted with the reader/writer, in a radio communication device that includes a plurality of IC chips for conducting radio communication with a reader/writer. Additionally, the communication control program is caused to determine whether or not radio communication is being conducted normally while the IC chip set to the exclusive-lock release state is conducting radio communication with the reader/writer, in the radio communication device that includes the plurality of IC chips for conducting radio communication with the reader/writer. Additionally, the communication control program is caused to set the IC chip set to the exclusive-lock release state to a exclusive-locked state that does not allow radio communication with the reader/writer when it is determined that the radio communication is not being conducted normally, and to set another IC chip that is different from the IC chip set to the exclusive-locked state to the exclusive-lock release state, in the radio communication device that includes the plurality of IC chips for conducting radio communication with the reader/writer. The communication control program may be distributed to a computer through a communication network such as the Internet and the like. Furthermore, the communication control program may be recorded on a memory, a hard disk, or another type of computer-readable recording medium provided in the radio communication device so that the program may be executed by being read from the recording medium by the computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A radio communication device comprising:
a plurality of IC chips that conducts radio communicate with a reader/writer;
a first setting unit that sets one IC chip selected from the plurality of IC chips to an exclusive-lock release state that allows radio communication to be conducted with the reader/writer;
a determination unit that determines whether the radio communication is being conducted normally when radio communication between the one IC chip set to the exclusive-lock release state and the reader/writer is conducted; and
a second setting unit that sets the one IC chip set to the exclusive-lock release state to a exclusive-locked state that does not allow radio communication with the reader/writer when the radio communication is determined as not being conducted normally, and sets another IC chip that is different from the one IC chip set to the exclusive-locked state to the exclusive-lock release state.

2. The radio communication device according to claim 1, wherein
the determination unit that determinates whether the radio communication is being conducted normally in accordance with whether information stored in the one IC chip set to the exclusive-lock release state is changed after conducting the radio communication.

3. The radio communication device according to claim 2, further comprising:
a memory in the radio device that stores information in the one IC chip before conducting the radio communication of the one IC chip set to the exclusive-lock release state, wherein
the determination unit that determinates whether a change has occurred to the information in the one IC chip after conducting the radio communication, by comparing the information stored in the one IC chip set to the exclusive-lock release state with the information stored in the memory, when radio communication is conducted between the one IC chip set to the exclusive-lock release state and the reader/writer.

4. The radio communication device according to claim 3, wherein
the determination unit that stores the information in the one IC chip set to the exclusive-lock release state in the memory, when determined that, by comparing the information stored in the one IC chip set to the exclusive-lock release state with the information stored in the memory, a change has occurred to the information in the one IC chip after conducting the radio communication.

5. The radio communication device according to claim 1, further comprising:
an electric power supplier that is mounted in the radio communication device to supply electric power only to the one IC chip set to the exclusive-lock release state among the plurality of IC chips.

6. The radio communication device according to claim 1, further comprising:
a timer controller that determinates that a preset time period has elapsed after the one IC chip set to the exclusive-lock release state has received a radio signal transmitted by the reader/writer, wherein
the determination unit whether radio communication between the one IC chip set to the exclusive-lock release state and the reader/writer is being conducted normally when determined that the present time period has elapsed.

7. An exclusive-lock control method for a radio communication device, the method comprising:
conducting radio communication device between a reader/writer and a plurality of IC chips mounted in a radio communication device carried by a user;
setting one IC chip selected from the plurality of IC chips to a exclusive-lock release state that allows radio communication to be conducted with the reader/writer;
determining whether the radio communication is being conducted normally when the radio communication between the one IC chip set to the exclusive-lock release state and the reader/writer is conducted; and
setting the one IC chip set to the exclusive-lock release state to a exclusive-locked state that does not allow radio communication with the reader/writer when the radio communication is determined as not being conducted normally, and setting another IC chip that is different from the one IC chip to the exclusive-lock release state.
